(19) United States
(12) Patent Application Publication
(10) Pub. No.: US 2014/0213073 A1
(43) Pub. Date: Jul. 31, 2014

(54) CONDUCTIVE HINGE

(71) Applicant: Steve Harvey, Austin, TX (US)

(72) Inventor: Steve Harvey, Austin, TX (US)

(21) Appl. No.: 14/162,733

(22) Filed: Jan. 23, 2014

Related U.S. Application Data
(60) Provisional application No. 61/757,184, filed on Jan. 27, 2013.

(51) Int. Cl. H01R 35/04

(52) U.S. Cl. CPC H01R 35/04
USPC 439/31

(57) ABSTRACT

Embodiments described herein disclose a conductive hinge that is configured to transfer power across a hinge regardless of the orientation of the faces of the hinge. In embodiments, the conductive hinge may be configured to be a conductive conduit to transfer constant power across the hinge. The conductive hinge may be used in conjunction with a conventional hinge, retrofitted to an existing hinge, and/or disposed within a hinge.

### CROSS-REFERENCE TO RELATED APPLICATIONS

This application claims a benefit of priority under 35 U.S.C. §119 to Provisional Application No. 61/757,184 filed on Jan. 27, 2013, entitled “CONDUCTIVE HINGE,” which is fully incorporated herein by reference in its entirety.

### TECHNICAL FIELD

This disclosure relates generally to systems and methods for a conductive hinge. Specifically, this disclosure relates to a hinge that is conductive regardless of the position of the hinge.

### BACKGROUND

Electrical components disposed on or within doors such as locks, actuators, lights, etc. require power. To supply power to these electrical components, conventional systems use hardwires to transfer power from a power supply directly to the electrical components. Other conventional systems use contacts positioned on both sides of a hinge that complete a circuit if the door is in a closed position.

Hardwires transferring power from a power supply to the components are subject to stress, wear, pinching, binding, breaking, bending, etc. from normal use. Normal wear and tear may cause the hardwires to lose conductivity or break. Hardwires may also impede the movement of a hinge and/or accidently catch on a foreign object causing lost conductivity within the hardwire.

Hinges that transfer power via contact points lose conductivity if the contact points are not adjacent to one another because a circuit will not be formed. Therefore, if the hinge is in an open position or ajar, a circuit will not be completed between the contact points. Accordingly, the contact points will not transfer power across the hinge. Further, contact points on the door are unreliable, may be accidently covered, and can be damaged due to regular use and the environment.

To this end, needs exist for an improved conductive hinge that efficiently transfers power across the faces of the hinge regardless of the positing of the hinge while also conserving space.

### SUMMARY

Embodiments described herein disclose a conductive hinge that is configured to transfer power across a hinge regardless of the orientation of the faces of the hinge. In embodiments, the conductive hinge may be configured to be a conductive conduit to transfer power across the hinge from an electrical power supply positioned on a first side of the conductive hinge to an electrical component positioned on a second side of the conductive hinge. The conductive hinge may be coupled to the power supply and the electrical component that requires power to operate.

In embodiments, the conductive hinge may transfer power from the power supply to the electrical component without an additional wire outside of the hinge. The conductive hinge may be used in conjunction with a conventional hinge, retrofitted to an existing hinge, and/or disposed within a hinge.

In embodiments, a first face of the hinge may be coupled with a first surface and a second face of the hinge may be coupled with a second surface. The first surface may be any known surface such as a dorm jam, body of refrigerator, table, automobile, recreational vehicle, etc. In further embodiments, the first surface may be fixed, allowing the hinge to rotate, turn or pivot. The second surface may be any known moveable surface such as a door, which may be a door of a refrigerator, door of an automobile, cabinet door, table, etc.

In embodiments, the power supply may generate and supply power to connectors disposed on the first face of the hinge. Power may be transferred across a pivot of the hinge, to connectors on the second face of the hinge. To transfer power from the connectors on the first face to connectors on the second face, power may traverse the pivot of the hinge. To minimize the power loss across the hinge, the pivot of the hinge may include a threaded fastener configured to receive a threaded bolt. The threaded bolt may couple with the threaded fastener within the hinge to increase the surface area of the points of contact, thus minimizing the loss of power across the hinge. However, in other embodiments the fastener and/or bolt may be unthreaded, ribbed, capped, or any other mechanism to interface a fastener and/or bolt.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 depicts one embodiment of a conductive hinge in an open position.

FIG. 2 depicts one embodiment of a conductive hinge in a closed position.

FIG. 3 depicts one embodiment of a conductive hinge coupled to a door frame.

FIG. 4 depicts one embodiment of a conductive hinge supplying power to electronic components.

FIGS. 5A-D depict embodiments of the parts comprising a conductive hinge.

FIG. 6 depicts one embodiment of a method a conductive hinge supplying power to electronic components.

Corresponding reference characters indicate corresponding components throughout the several views of the drawings. It should be appreciated that elements in the figures are illustrated for simplicity and clarity and have not necessarily been drawn to scale. For example, the dimensions of some of the elements in the figures may be exaggerated relative to other elements to help improve understanding of various embodiments of the present disclosure. Further, common but well-understood elements that are useful or necessary in a commercially feasible embodiment are often not depicted in order to facilitate a less obstructed view of the various embodiments of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

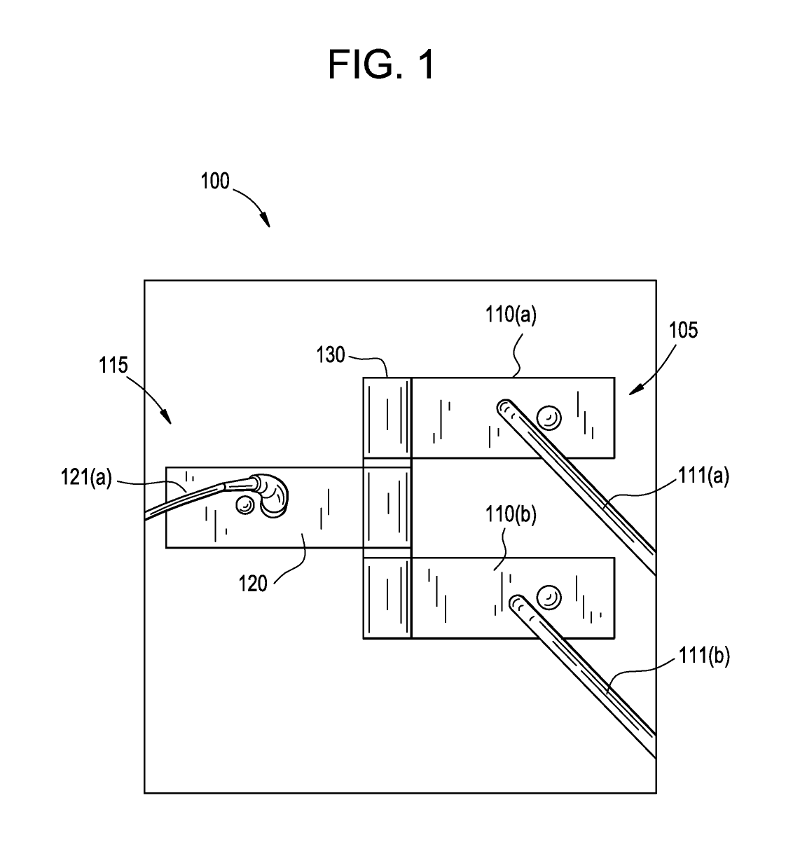

Referring now to FIG. 1, an embodiment for transferring power across a conductive hinge 100 is depicted. Conductive hinge 100 is depicted in an open position. Conductive hinge 100 may include projections 110(a) and 110(b) on a first side 105 of conductive hinge 100, projection 120 on a second side 115 of conductive hinge 100, and pivot 130. Conductive hinge 100 is in an open position in response to projections 110(a) and 110(b) being rotated away from projection 120. If projections 110(a) and 110(b) are rotated towards projection 120, then conductive hinge may be in the closed position. However, regardless of the orientation of conductive hinge 100, conductive hinge is configured to transfer power from connectors disposed on projections 110(a) and 110(b) to connectors disposed on projection 120.

Projections 110(a) and 110(b) may be configured to couple with a fixed frame, such as a door jamb. Projection 120 may be configured to couple with a surface, such as a door. In embodiments, the fixed frame may be configured to bear the weight of the surface through conductive hinge 100. Projections 110(a) and 110(b) may be comprised of any electrical insulator that limits or restricts electric charges to freely flow, such as nylon, rubber, plastic, fiber glass, etc. Therefore, in an embodiment, a surface of projections 110(a) and 110(b) may not be conductive.

Projections 110(a) and 110(b) may include connectors 111(a) and 111(b), respectively. Connectors 111(a) and 111(b) may be comprised of any conductive material, such as silver, copper, gold, etc. Connectors 111(a) and 111(b) may extend from a surface of projections 110(a) and 110(b) to pivot 130. In an embodiment, a power supply may be configured to couple with connector 111(a) disposed within projection 110(a) and connector 111(b) disposed within projection 110(b). In an embodiment, connector 111(a) may be configured to receive a power signal from the power supply and connector 111(b) may be configured to be grounded. However, one skilled in the art will appreciate that either connector 111(a) or connector 111(b) may be connected to a power supply and/or be grounded. As depicted in FIG. 1, if conductive hinge 100 is in an open position, then projections 110(a) and 110(b) may be angled away from projection 120 by rotating projection 120 or projections 110(a) and 110(b) about pivot 130.

Pivot 130 may be comprised of any conductive material, and may be configured to electrically interface with connectors 111(a) and 111(b).

Pivot 130 may receive power supplied by connectors 111(a) and/or 111(b) and transmit the power to a connector 121(a) disposed on a surface of projection 120, where connector 121(a) may be comprised of any conductive material. Pivot 130 may transfer power supplied from a power source disposed on the first side, which may include a fixed frame, of conductive hinge 100 to power an electrical component on the surface side of conductive hinge 100. In embodiments, the electrical component may be any device utilizing electrical power, such as power locks, lights, power windows, etc.

In further embodiments, pivot 130 may be covered by an insulating material, such as rubber, glass, plastic, etc. The insulating material may be configured to protect a user from the electrical current traversing pivot 130.

In embodiments, because conductive hinge 100 may transfer power regardless of the orientation of conductive hinge 100, electrical components may be powered a power supply if desired. For example, a light positioned on a rotating portion of a door may be lite up regardless of the door is opened or closed.

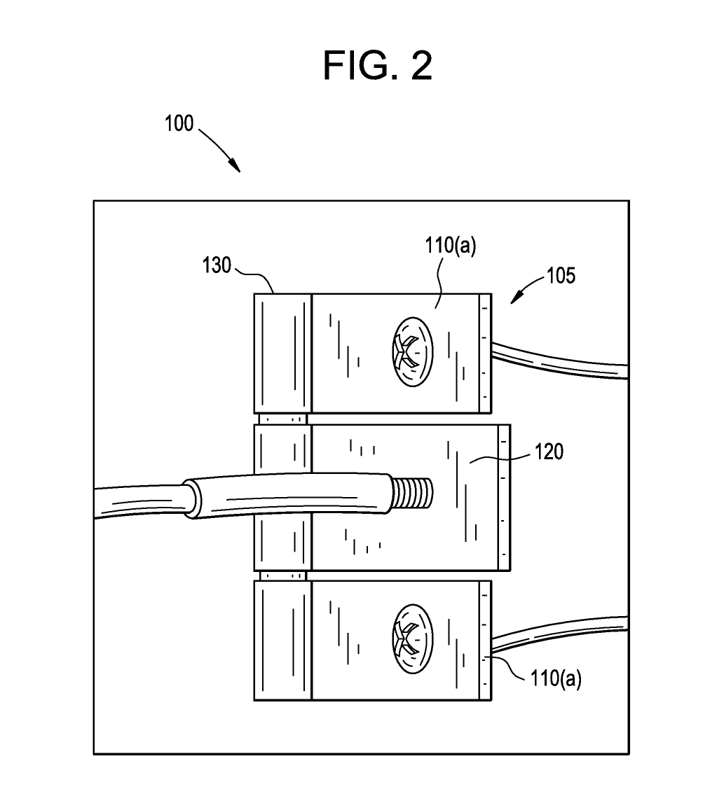

FIG. 2 depicts an embodiment of conductive hinge 100 in a closed position. Because conductive hinge 100 transfers power from a power supply to an electrical component via pivot 130, conductive hinge 100 can transfer power regardless of whether conductive hinge 100 is in an open position or a closed position without an additional wire extending across conductive hinge 100. As depicted in FIG. 2, if conductive hinge 100 is in a closed position, then projections 110(a) and 110(b) may be adjacent to projection 120.

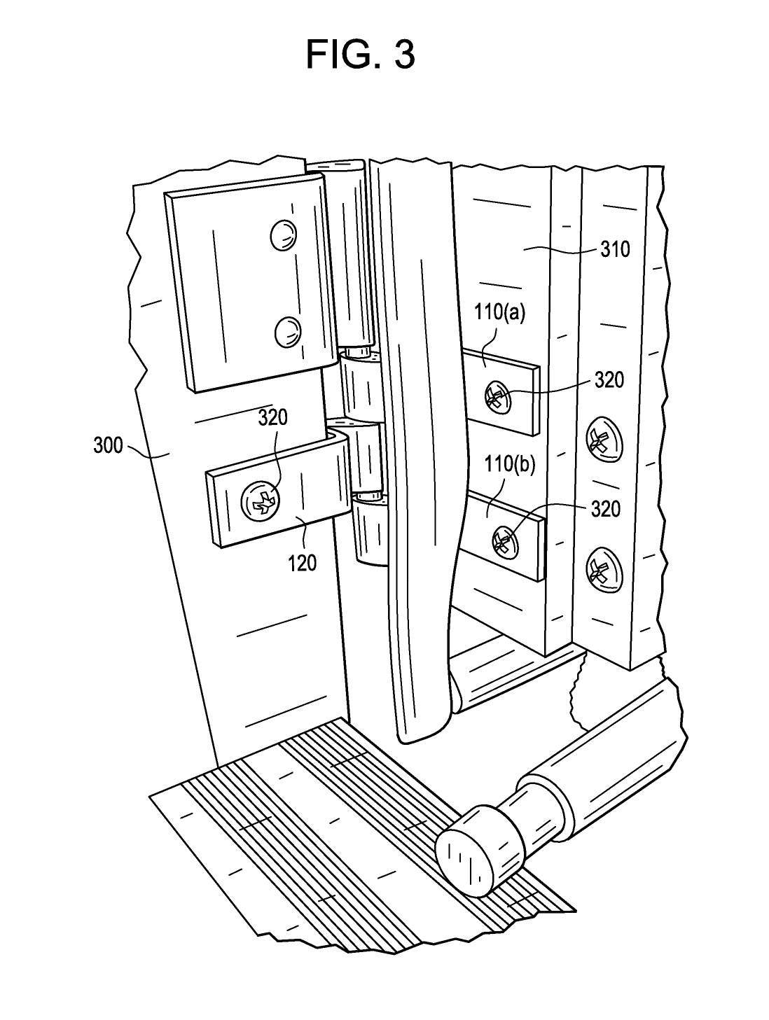

FIG. 3 depicts an embodiment of conductive hinge 100 coupled with a fixed frame 300 and a surface 310. Conductive hinge 100 may be coupled to frame 300 and surface 310 via fasteners 320. Fasteners 320 may be any device configured to extend from a surface of projections 110(a), 110(b), and/or 120, through projections 110(a), 110(b), and/or 120 and into frame 300 and surface 310 to couple conductive hinge 100 to frame 300 and surface 310. In embodiments, fasteners 320 may be screws, bolts, nails, etc.

In further embodiments, a rubber seal 410 may be disposed over pivot 130, and extending across a plane of rotation to protect against weather and/or mechanical use. Rubber seal 410 may be comprised of any material that is configured to be an electrical insulator.

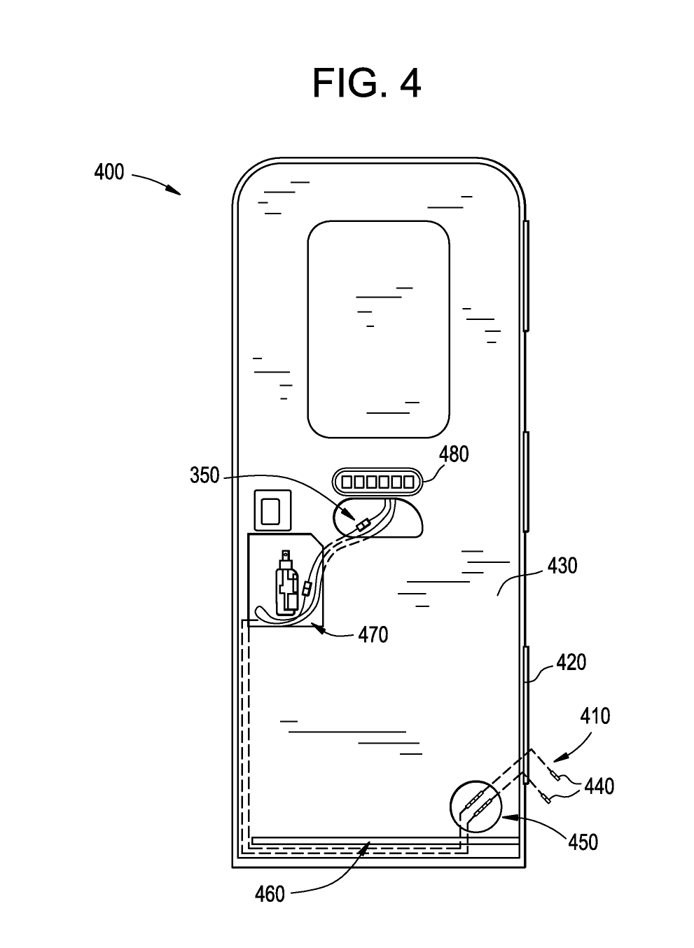

FIG. 4 depicts an embodiment of topology 400 transferring power across conductive hinge 410. Topology 400 may include hinges 420 configured to support door 430 to a door jamb (not shown).

Hinges 420 may be any known conventional hinge configured to couple door to the door jamb. Conductive hinge 410 may be configured to be used in conjunction with hinges 420, and may be substantially the same size and shape as hinges 420. Conductive hinge 410 may be configured to transfer power within an inner portion of conductive hinge 410, while the surface of conductive hinge 410 may be insulated.

Conductive hinge 410 may include power couplers 440 configured to receive power from a power source (not shown) and transfer power across conductive hinge 410 to output couplers 450. Output couplers 450 may be configured to supply power to a plurality of components on the door side of conductive hinge 410. The power used to power the components may be the power received via power couplers 440. In embodiments output couplers 450 may be configured to supply power to a light 460 and an actuator 470. Wherein, actuator 470 may control a door lock 480.

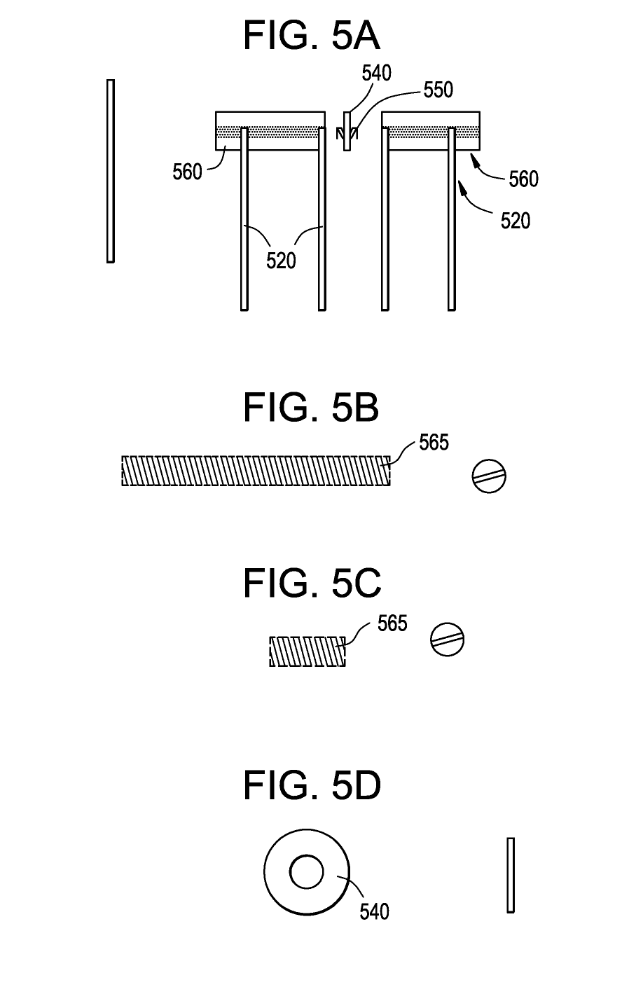

FIG. 5 depicts an exploded view of components comprising conductive hinge 100. Conductive hinge 100 may include projection conductors 520, conductive pivot 530, washer 540, and fastener 550.

Projection conductors 520 may be configured to receive power from a power supply. Projection conductors 520 may be any known conductive material, such as copper, and may be coupled with conductive pivot 530. In an embodiment, projection conductors 520 may be coupled to conductive pivot 530 by extending from surface into a body of conductive pivot 530. In further embodiments, an end of projection conductors 520 may be bent to project away from the body of the projection conductors 520. The bent portion of projection conductors 520 may be configured to extend away from the body of the projection conductors 520 to receive power from a power supply and/or distribute power to another component.

Conductive pivot 530 may be configured to receive power from projection conductors 520, and transfer power to other projection conductive (not shown) positioned on an opposite side of pivot 530 from projection conductors 520. Conductive pivot 530 may be comprised of any conductive material, which may or may not be the same material as projection conductors 520. In one embodiment, pivot 530 may be comprised of brass. In another embodiment, pivot 530 may be positioned perpendicular to projection conductors 520. Conductive pivot 530 may include a threaded barrel 560 that is configured to receive a threaded fastener 565. Threaded fastener 565 and treaded barrel 560 may be threaded, ribbed, ridged, or any other mechanism to increase the surface area of contact between the two to minimize the power loss across conductive hinge 110. In embodiments, if conductive hinge 110 is coupled to a frame (not shown) and a surface (not shown), to support the surface, the surface may apply pressure to conductive hinge 110. By applying the pressure to conductive hinge 110, the threads in threaded fastener 565 may be placed adjacent to the grooves in threaded barrel 560, thus increasing the contact area between them. Accordingly, rotational movement of the surface around conductive pivot 530 may increase the conductivity of conductive hinge 110.

A plurality of conductive hinges 110 may be coupled together via fastener 550. Fastener 550 may be any type of insulating material, such as nylon. Fastener 550 may be configured to interface with the groove of threaded barrel 560 to couple the plurality of conductive hinges 510. In further embodiments, fastener 550 may be configured to extend through a washer 540. Washer 540 may be an insulating material, configured to be positioned between a pluralities of conductive hinges 510. Washer 540 may be utilized to distribute the load of fastener 550 to conductive hinge 110, and protect against weathering.

In embodiments, conductive hinge 110 may be disposed in an insulating material, such as fiber glass, plastic, etc. The insulating material may be any desired shape and/or size, such as the shape of any conventional hinge. If conductive hinge 110 is disposed in an insulating material, the bend portions of conductive projections 510 may extend past the insulating material to receive and/or transfer power to and from other components.

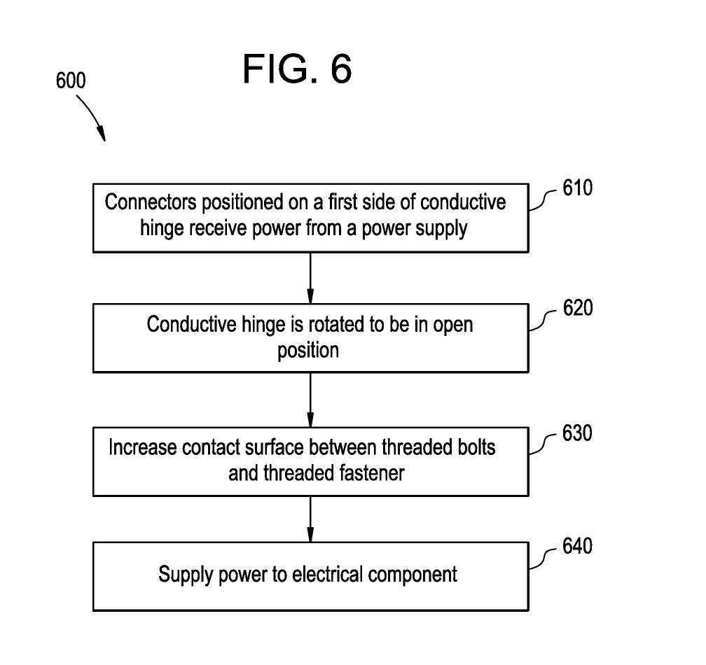

FIG. 6 illustrates a method 600 for transferring power across a conductive hinge. The operations of method 600 presented below are intended to be illustrative. In some embodiments, method 600 may be accomplished with one or more additional operations not described, and/or without one or more of the operations discussed. Additionally, the order in which the operations of method 600 are illustrated in FIG. 6 and described below is not intended to be limiting.

At operating 610, connectors positioned on a first side of a conductive hinge may receive power from a power supply. Operation 610 may be performed by a connector that is the same as or similar to connectors 111(a) or 111(b), in accordance with one or more implementations.

At operation 620, the conductive hinge may be rotated to be in an open position. Responsive to the conductive hinge being in the open position, a first surface coupled to a first side of the conductive hinge may not be positioned adjacent to a second surface coupled to a second side of the conductive hinge. Operation 620 may be performed by a conductive hinge that is the same as or similar to conductive hinge 100, in accordance with one or more implementations.

At operation 630, responsive to the conductive hinge being in the open position, the weight of the first surface may cause a threaded bolt to contact a threaded fastener within the conductive hinge to increase the surface area of the contact points between the threaded fastener and the threaded bolt. Operation 630 may be performed by a conductive hinge that is the same as or similar to conductive hinge 100, in accordance with one or more implementations.

At operation 640, an electrical component positioned on the first surface may receive power from the power supply even if the conductive hinge is in the first position. Responsive to receiving power, the electrical component may be operated. Operation 640 may be performed by a conductive hinge that is the same as or similar to conductive hinge 100, in accordance with one or more implementations.

In the foregoing specification, embodiments have been described with reference to specific embodiments. However, one skilled in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function).

Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment,” “an embodiment,” or “a specific embodiment” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment.

Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

Furthermore, the term “or” as used herein is generally intended to mean “and/or” unless otherwise indicated. As used herein, a term preceded by “a” or “an” (and “the” when antecedent basis is “a” or “an”) includes both singular and plural of such term (i.e., that the reference “a” or “an” clearly indicates only the singular or only the plural). Also, as used in the description herein, the meaning of “in” includes “in” and “on” unless the context clearly dictates otherwise.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A conductive hinge comprising:
a first conductor disposed on a first side of the conductive hinge, the first conductor being configured to receive power from a power source;
a second conductor disposed on a second side of the conductive hinge, the second conductor being configured to transmit power to an electrical component;
a conductive pivot configured to receive power from the first conductor and transfer power to the second conductor, wherein the conductive pivot is configured to transfer power from the first conductor to the second conductor when a door is in an open position and when the door is in a closed position; and
an insulator configured to encompass the conductive hinge, wherein the first conductor includes a first connectivity point configured to extend from the first conductor across the insulator and the second conductor includes a second connectivity point configured to extend from the second conductor to across the insulator.

2. The conductive hinge of claim 1, wherein the first conductor is coupled to a door jamb and the second conductor is coupled to a door.

3. The conductive hinge of claim 2, wherein the conductive pivot includes a threaded barrel configured to receive a threaded fastener.

4. The conductive hinge of claim 3, wherein if the conductive pivot is in the open position, a weight of door against the conductive pivot increases the contact points between the threaded barrel and the threaded fastener.

5. The conductive hinge of claim 1, wherein the first side of the conductive hinge is a different side of the conductive hinge than the second side.

6. The conductive hinge of claim 1, wherein no wires external from the conductive pivot are required to transfer the power across the conductive pivot.

7. The conductive hinge of claim 1, wherein the first side of the conductive pivot is not required to be positioned adjacent to the second side of the conductive pivot to transfer the power across the conductive pivot.

8. The conductive hinge of claim 1, further comprising:
a third conductor disposed on the first side of the conductive hinge, the third conductor being configured to be grounded.

9. The conductive hinge of claim 1, wherein the conductive pivot is configured to be rotated to open and close the conductive hinge.

10. The conductive hinge of claim 1, wherein the first conductor and the second conductor are positioned perpendicular to the conductive pivot.

11. A method comprising:
receiving power by a first connector disposed on a first side of the conductive hinge on a first side of the conductive hinge;
transmitting power by a second conductor disposed on a second side of the conductive hinge to an electrical component;
receive power by a conductive pivot from the first conductor;
transferring power across the conductive pivot to the second conductor, wherein the conductive pivot configured to transfer power from the first conductor to the second conductor whether the door is in an open position or the door is in a closed position; and
encompassing the conductive hinge with an insulator, wherein the first conductor includes a first connectivity point configured to extend from the first conductor across the insulator and the second conductor includes a second connectivity point configured to extend from the second conductor to across the insulator.

12. The method of claim 11, further comprising:
coupling the first conductor to a door jamb; and
coupling the second conductor is coupled to a door.

13. The method of claim 12, wherein the conductive pivot includes a threaded barrel configured to receive a threaded fastener.

14. The method of claim 13, further comprising:
rotating the conductive pivot to be in the open position; and
increasing the contact points between the threaded barrel and the threaded fastener responsive to a weight of the door when the conductive pivot is in the open position.

15. The method of claim 11, wherein the first side of the conductive hinge is a different side of the conductive hinge than the second side.

16. The method of claim 11, further comprising:
transferring power across the conductive pivot with an external wire.

17. The method of claim 11, wherein the first side of the conductive pivot is not required to be positioned adjacent to the second side of the conductive pivot to transfer the power across the conductive pivot.

18. The method claim 11, further comprising:
coupling a third conductor disposed on the first side of the conductive hinge to a ground.

19. The method claim 11, further comprising:
rotating the conductive pivot to open and close the conductive hinge.

20. The method claim 11, wherein the first conductor and the second conductor are positioned perpendicular to the conductive pivot.
